(19) United States
(12) Patent Application Publication
(10) Pub. No.: US 2017/0344713 A1
(43) Pub. Date: Nov. 30, 2017

(54) DEVICE, SYSTEM AND METHOD FOR ASSESSING INFORMATION NEEDS OF A PERSON

(71) Applicant: KONINKLIJKE PHILIPS N.V., EINDHOVEN (NL)

(72) Inventors: Jarno Mikael RIISTAMA, Waarle (NL); Monique HENDRIKS, Eindhoven (NL); Johannes Henricus Maria KORST, Eindhoven (NL)

(21) Appl. No.: 15/534,066

(22) PCT Filed: Dec. 11, 2015
(86) PCT No.: PCT/EP2015/079498

§ 371 Date: Jun. 8, 2017

(30) Foreign Application Priority Data
Dec. 12, 2014 (EP) 14197649.8

(51) Int. Cl. G06F 19/00; G06F 17/30; G10L 15/22; G06K 9/00

(52) U.S. Cl. CPC G06F 19/345; G06K 9/00355; G06F 19/321; G06K 9/00302; G06F 17/30528; G10L 15/22; G06K 9/00892; G06F 19/3431; G06K 2009/00939; G06F 19/363; G10L 2015/223

(57) ABSTRACT

The present invention relates to a device, system and method for assessing the information needs of a person. The device comprises an input interface (130) for receiving speech content information of the person, an image data interface (131) for receiving image data of the person depicting the person during said speech, a physiological data interface (132) for receiving physiological data of the person obtained during said speech, a data analyzer (133) for analyzing the received speech content information, image data and physiological data and for deriving a topic of the speech from the received speech content information, for deriving one or more vital signs and reactions of the person from the received image data and for deriving emotions of the person from the received physiological data, an information needs determining unit (134) for determining information needs of the person from the topic of speech, one or more vital signs, reactions and emotions of the person derived by the data analyzer, and an output interface (135) for outputting the determined information needs of the person.

### FIELD OF THE INVENTION

The present invention relates to a device, system and method for assessing information needs of a person. The present invention relates further to a computer program for implementing said method.

### BACKGROUND OF THE INVENTION

Today, healthcare requires an active involvement of a patient in information sharing and decision making. Often, many treatment options are available, all with their own success rates and possible side effects. A patient's own preferences should be taken into account during the decision making process. Such shared decision making requires the doctor to understand the patient's preferences and the patient to understand the different treatment options and their consequences.

Successful information sharing and collaborative decision making in healthcare means that the information needs of both doctor and patient should be satisfied. A doctor is generally trained in satisfying his own information needs for making a diagnosis (asking the right questions, performing the right tests). A patient is generally not trained in satisfying his/her information needs. Doctors can be trained to assess patient's information needs, but this is difficult, because patient information needs are often very personal and there are several psychological mechanisms hiding a patient's actual information needs.

Different patient information needs may arise from personal characteristics such as:
The patient's information processing capabilities; memory and attention. There are personal differences in memory and attention, on top of that, memory and attention may also be affected by the disease from which the patient is suffering and/or the treatment the patient is currently being given.
Whether or not the patient has a tendency to ruminate. Rumination interferes with effective problem solving thinking and therefore a patient who is ruminating should be approached differently in the process of shared decision making than a patient who is capable of problem solving thinking
Whether the patient feels confident to make a decision. Patients who have a low self efficacy, a low feeling of confidence in general, or patients who experience anxiety, may not feel up to the task to decide about their future.
Whether the patient has a tendency towards cognitive closure. Patients who have a tendency towards cognitive closure as opposed to critical thinking, feel a “desire for predictability”, “discomfort with ambiguity”, they are “close-minded”. Therefore, these patients tend to show a preference for less information (they tend to underestimate their own information need required for making the decision). In order to effectively involve these patients to make an informed decision, they should be approached differently with respect to information sharing regarding treatment options and their consequences than patients who tend to employ more critical thinking.
The patient's perception of risk. Patients who have a stronger attitude towards taking risks should be approached differently in the information sharing and shared decision making process than patients who have a stronger attitude towards avoiding risks. The former should be made more aware of the risks involved and possible consequences, while the latter should be made more aware of positive outcomes of taking the risk for a certain treatment.

In Medicine Personalized, “Deliverable No. 2.5—Specification of tools and services supporting patient empowerment”, Actual Submission Date 31 Jan. 2012, questionnaires are developed to assess, among others, these factors. The aim is that these questionnaires are filled in by the patient in the waiting room before the consult with the doctor. The doctor is informed of the results of the questionnaire through a few key words.

Aside from such questionnaires though, not much literature is available on how doctors should deal with a patient's personal information needs arising from the psychological/cognitive aspects mentioned above. Most literature on shared decision making in health care focusses on patient's information need only in the sense of how information sharing is related to patient satisfaction; how much information do patients want to obtain. There is a gap in the research here, concerning how much and which information they need to obtain in order to make an informed decision. As mentioned above, this need may be different from what is desired by the patient (as in patients with a tendency towards cognitive closure) and, more importantly, this need may also not be consciously known by the patient (people are generally not aware of their own perception of risk for example).

However, once the personal characteristics of a patient which influence their information need (these may consist of, but are certainly not limited to the characteristics mentioned above) are assessed, there are indications of how to deal with these different information needs. So, if a doctor is made aware of these personal characteristics of each individual patient he talks to, this may enable him to better steer the discussion towards a successful shared decision making process.

Patient empowerment and shared decision making in health care are currently being approached mainly from a patient satisfaction perspective. Much research has been done to investigate what patients want to know about their disease and the different treatment options. However, in order to enable effective shared decision making, it should be focused on what patients need to know in order to make an informed decision. What patients want to know and what they need to know, may differ substantially.

Information needs are very personal. Several characteristics influencing a patient's information needs have been mentioned. Patients themselves however, may not be aware of these personal characteristics and how they influence their information needs. Doctors should be aware of them, in order to enable a successful shared decision making process. Doctors should be able to inform their patients regarding their disease and treatment options in such a way that the patient truly understands his options and their consequences. To achieve this, they should be aware of the patient's personal characteristics which influence their information needs and they should deal with them accordingly.

However, finding out these personal characteristics in a person that the doctor/one has never been met before, or has only talked to shortly, is a time consuming process. There may be several ways, in particular to have long conversations with them to find out what their attitude and capabilities are, or observe them for a longer period of time in interaction with others, or ask their closest family and friends, or ask a psychologist to interview them, etc. All of these options are very time and resource consuming. A less time and resource consuming option is to let patient's fill in a questionnaire before their consult. However, the questionnaire, i.e. the ALGA questionnaire, which can currently be found at http://www.surveymonkey.com/s/7Z8G563, is very time consuming for the patient and might be perceived as unpleasant to fill in due to the nature of the questions. Furthermore, patients may not always fill in these questions honestly. It is a well-known phenomenon that people will answer questions in a socially acceptable way: e.g. “How much do you exercise?”, “To what extent were you sexually active?”. Furthermore, for some questions, it is difficult to answer them honestly since the answer has been forgotten or the person may not actually be aware that what he answers is not actually true (the person's self-image is different from what others perceive about person).

Hence, there is no good option available for assessing a patient personal characteristics such that the doctor can correctly and efficiently assess the patient's information needs.

### SUMMARY OF THE INVENTION

It is an object of the present invention to provide a device, system and method for assessing information needs of a person, which overcome the above mentioned shortcomings and in particular allow an easy, efficient and preferably unobtrusive way for assessing information needs of a person.

In a first aspect of the present invention a device for assessing information needs of a person is presented comprising:
an input interface for receiving speech content information of the person,
an image data interface for receiving image data of the person depicting the person during said speech,
a physiological data interface for receiving physiological data of the person obtained during said speech,
a data analyzer for analyzing the received speech content information, image data and physiological data and for deriving a topic of the speech from the received speech content information, for deriving one or more vital signs and reactions of the person from the received image data and for deriving emotions of the person from the received physiological data,
an information needs determining unit for determining information needs of the person from the topic of speech, one or more vital signs, reactions and emotions of the person derived by the data analyzer, and
an output interface for outputting the determined information needs of the person.

In a further aspect of the present invention a system for assessing information needs of a person is presented comprising:
a speech content information acquisition unit for acquiring speech content,
an imaging unit for acquiring image data of the person depicting the person during said speech,
a physiological data sensor for acquiring physiological data of the person obtained during said speech,
a device as disclosed herein for assessing information needs of the person, and
a user interface for issuing the determined information needs of the person for perception by a user.

In a further aspect of the present invention a method for assessing information needs of a person is presented comprising:
receiving speech content information of the person,
receiving image data of the person depicting the person during said speech,
receiving physiological data of the person obtained during said speech,
analyzing the received speech content information, image data and physiological data and for deriving a topic of the speech from the received speech content information, for deriving one or more vital signs and reactions of the person from the received image data and for deriving emotions of the person from the received physiological data,
determining information needs of the person from the topic of speech, one or more vital signs, reactions and emotions of the person derived by the data analyzer, and
outputting the determined information needs of the person.

It will be appreciated by the skilled in the art that the speech content information of the person may include information about the content of speech of said person.

In yet further aspects of the present invention, there are provided a computer program which comprises program code means for causing a computer to perform the steps of the method disclosed herein when said computer program is carried out on a computer as well as a non-transitory computer-readable recording medium that stores therein a computer program product, which, when executed by a processor, causes the method disclosed herein to be performed.

Preferred embodiments of the invention are defined in the dependent claims. It shall be understood that the claimed system, method, computer program and medium have similar and/or identical preferred embodiments as the claimed device and as defined in the dependent claims.

The present invention is based on the idea to use different sources of information that can be gained about the person in an unobtrusive way and to process said information to assess the individual information needs of the person, e.g. of a patient currently in consultation. The person's information needs may be fed back to the user, e.g. a doctor, either during the consultation or before the next consultation.

The sources of information may include a camera or video recording system, an audio recording system, a number of devices measuring physiological responses in the person, or a combination of such devices, preferably connected to a processor that semantically analyzes the recordings and estimates the patient's characteristics. In particular, to derive information needs of the person a topic of speech, one or more vital signs, reactions and emotions of the person are analyzed according to the present invention. A device with a screen may be used as user interface to provide feedback to the user regarding the person's estimated characteristics during, before or after a communication with the person, i.e. the information needs of the person is indicated to the user (e.g., care provider such as a doctor or nurse), in any way.

The proposed device, system and method provide a quick and easy way, e.g. for care providers, to indicate the person's information needs at the point of service, and a set of recommendations to tailor their communication/information delivery to the information needs of the person. Accordingly, in an embodiment the device further comprises a recommendations generator for generating a recommendation how to tailor communication, content of information delivery and/or information delivery style to be provided to the person according to the determined information needs of the person. Via the output interface the recommendation can be output and thus delivered to the user to tailor the communication and information, e.g. healthcare and guidance information accordingly. As a consequence, the effectiveness of e.g. therapeutic intervention strategies can be improved if the proposed invention is used for improving communication between a care provider and a patient to tailor healthcare and guidance information.

The proposed device uses an input interface for receiving speech content information including information about the content of speech of the person. Said speech content information may include audio data of speech spoken by the person (e.g. during a communication between the person and a user, or of a speech held by the person, or of speech spoken into a microphone, e.g. in response to a questionnaire run on a computer), video data of at least the person's mouth (e.g. video data taken from a camera monitoring the person) and/or text data indicating the content of the person's speech (e.g. information taken from a database or a text analysis tool or written down by the user). Generally, it is not essential how the content information is obtained, as long as the content information is suitable for deriving topics of the speech of the person. The input interface may also receive audio data files of recorded speech. Hence, the speech may be recorded on the fly or prerecorded and evaluated at a later time.

The proposed device further uses an image data interface for receiving image data of the person depicting the person during said speech. Said image data interface is preferably configured to receive a sequence of image frames of the person, said image frames including image data of one or more skin areas of the person. Said image data are preferably used to obtain one or more vital signs of the person from said sequence of image frames by use of remote photo-plethysmography (PPG). Non-contact, remote PPG (rPPG) devices (also called camera rPPG devices) for unobtrusive measurements of vital signs is generally known, e.g. from Verkruysse et al., “Remote plethysmographic imaging using ambient light”, Optics Express, 16(26), 22 Dec. 2008, pp. 21434-21445. Photo-plethysmography (PPG) is an optical measurement technique that evaluates a time-variant change of light reflectance or transmission of an area or volume of interest. It is based on the principle that blood absorbs light more than surrounding tissue, so variations in blood volume with every heart beat affect transmission or reflectance correspondingly. Besides information about the heart rate, a PPG waveform can comprise information attributable to further physiological phenomena such as the respiration. By evaluating the transmittance and/or reflectivity at different wavelengths (typically red and infrared), the blood oxygen saturation can be determined. Remote PPG utilizes light sources disposed remotely from the subject of interest. Similarly, also a detector, e.g., a camera or a photo detector, can be disposed remotely from the subject of interest. Therefore, remote photo-plethysmographic systems and devices are considered unobtrusive and well suited for medical as well as non-medical everyday applications.

The proposed device further uses a physiological data interface for receiving physiological data of the person obtained during said speech. Said physiological data may generally be any kind of physiological data, such as data about the blood pressure, temperature, skin conductance, heart rate, respiration rate, SpO2, etc., i.e. generally any physiological data that can be measured in any way from the person by appropriate sensors or, preferably, in an unobtrusive way.

The proposed device further uses a data analyzer for analyzing the received data and for deriving a topic of the speech from the received speech content information, one or more vital signs and reactions of the person from the received image data and emotions of the person from the received physiological data. Said data analyzer preferably comprises a person recognition unit for identifying the person from the received data, wherein the device further comprises a personal data input for obtaining personal data of the identified person, and wherein said information needs determining unit is configured to use said personal data for determining information needs of the person.

The device may make use of an electronic health record of the patient as an additional source of information. Depending on the type of disease a number of patient information needs can be considered appropriate. This helps to decrease the number of possible information needs. For instance, a data input may be provided for obtaining healthcare information of the person, wherein the data analyzer is configured to process said healthcare information (e.g. to analyze the text) and said information needs determining unit is configured to use said healthcare information in determining information needs of the person. The data input may also use information from the person recognition unit to know the person for whom healthcare information shall be obtained.

The configuration of the data analyzer depends on the particular application and design of the device. In practical implementations the data analyzer comprises one or more of
a facial expression recognition module for recognizing facial expressions of the person from the received image data,
a gesture recognition module for recognizing gestures of the person from the received image data,
a voice analysis module for analyzing the voice of the person from received audio data,
a text analysis module for analyzing received text information, and
a facial color detection module for detecting the color and/or color changes of the person from the received image data.

The proposed device further uses an information needs determining unit for determining information needs of the person from the derived topic of speech, one or more vital signs, reactions and emotions of the person. Preferably, said information needs determining unit is configured to determine personal characteristics of the person by use of one or more markers, wherein said one or markers correlate personal characteristic with one or more topics of speech, vital signs, reactions and/or emotions of the person, and to determine information needs based on the determined personal characteristics. For each characteristic, a number of recognition markers may be defined, e.g. “not talking much” or “keeps repeating the same concern(s)” may be defined as markers of rumination, “does not ask questions” and “doesn't appear to be actively listening” may be defined as markers of cognitive closure and so on. These markers can be taken from expert knowledge (e.g. from psychologists or psychological literature), or they can be derived from an experiment where participant's behavior is recorded via video, audio and or physiological measures and they are asked to fill in questionnaires or talk to a psychologist afterwards in order to get an indication of their psychological profile. Correlations between recorded behaviors and psychological profile indicate which behaviors can be used as markers. The markers might be refined by applying adaptive learning techniques during use of the system.

The speech content information acquisition unit of the system used for acquiring speech content information including information about the content of speech of the person preferably comprises i) an audio data interface for receiving audio data files of recorded speech and/or ii) an audio recording unit, in particular a microphone, for converting spoken speech into electric speech signals and/or iii) an interrogator for interrogating the person.

The user interface of the system may generally be used for outputting the identified information needs and/or the generated recommendations for use by the person or the user, in particular a caregiver (also called healthcare provider or healthcare professional), for tailoring communication and/or information, in particular healthcare and guidance information, to be provided to the person. Said user interface may further include a display, for instance on a patient monitor, the care provider's computer screen, smartphone or tablet. Other output interfaces, such as loudspeakers, may also be used.

For practical use the system may be designed in different ways. Preferably, the system is incorporated into or configured as a handheld or mobile device, in particular a smartphone, tablet, laptop, wrist-mounted device or camera. In other embodiments the elements of the system are implemented as different entities, using e.g. a computer or processor for analyzing and processing data acquired from different (external) sensors and an output device for outputting information for use by the user and/or the person.

In an exemplary embodiment the communication style in a face-to-face conversation is adapted. This may entail for example that the user, e.g. a healthcare professional, is guided to adopt an empathic style for a person that has a sensitive personality. Further, recommendations may be made which tone of voice and which type of language would be appropriate for this person (e.g. use soft tone of voice, show empathy by summarizing the feelings expressed by the patient, acknowledge how difficult it is, etc.).

Preferably, the speech (i.e. the spoken language) is first translated into text so that in the subsequent step the spoken language and/or the text is analyzed to identify the topic of the speech and the person's information needs.

Advantageously, said data analyzer is configured to determine in the received speech and/or the text one or more of
the amount and/or length of pauses,
the length of sentences and/or words,
the amount of words in a sentence,
the amount of personal pronouns and/or possessive pronouns,
the amount of verbs, nouns and/or adjectives,
the amount of words with predetermined prefixes and/or endings,
the amount of layman's words or phrases,
the amount how much the person speaks about a predetermined topic,
the extent to which the person uses predetermined words or phrases,
the percentage of second person words,
the variance in pitch.

It has been found that such natural language elements in speech and/or text may also be correlated to the information needs of a person so that their evaluation is useful in determining the information needs of a person. Other natural language elements, that may e.g. only become apparent through future research, may be used as well.

In another embodiment the device further comprises an information needs database comprising a plurality of different information needs and corresponding natural language elements, wherein said information needs determining unit is configured to access said information needs database and select the information need of the person based on the identified natural language elements. The information needs database is preferably predetermined, but can also be updated over time as a kind of learning system. The use of an information needs database provides a simple and quick method for determining the information needs.

Preferably, the device further comprises a recommendations database comprising a plurality of recommendations and corresponding information needs, wherein said output interface is configured to access said recommendations database and select the recommendations based on the identified information needs of the person. The recommendations database is preferably predetermined, but can also be updated over time as a kind of learning system. The use of a recommendations database provides a simple and quick method for determining the recommendations. Thus, the main idea of this embodiment is that these recommendations are stored in a database. The device finds the right set of recommendations based on the processed data and presents these to the user in an actionable format, e.g. on his computer screen.

In another embodiment said input interface further comprises an interrogator for interrogating the person. Thus, the system provides questions, e.g. on a display or as spoken questions, to the person, which the person has to answer (by vocalizing the answer) so that the system can process the speech as explained above. The interrogator is preferably implemented on a computer, e.g. as a corresponding software, and may be adapted to the person. Further, the interrogator may evaluate the given answers and adapt the next questions accordingly in order to get as much useful speech as possible in order to determine the person's information needs as reliably as possible. Alternatively, the questions of the interrogator are presented as a recommendation for the user (e.g. the healthcare provider) to be asked by the user himself (rather than letting them be asked by the interrogator). This would allow for a more natural conversation.

It may not always be possible to exactly indicate the correct information needs of the person. This may even be changing over time, e.g. during an interrogation. Hence, in an embodiment, additional information, like the most dominant momentary information needs of the person and a momentary certainty level indicating the likelihood of the identified information needs being the most dominant information needs, is identified.

Accordingly, in an embodiment said output interface is configured to output an indication of the most dominant information needs of the person and the certainty level and to update this indication over time according to changes of the information needs and/or the certainty level. For instance, a displayed indication of the most dominant information needs of the person and the certainty level may change, e.g. in color, size, etc. when the most dominant information needs of the person and/or the certainty level changes.

The device may further comprise an optimizer for determining the information entropy of one or more possible next questions which may be used for interrogating the person and for selecting the possible next question providing the highest information entropy. Thus, the next question(s) to be used is (are) actively selected in order to obtain as much information as possible that is useful in determining the person's information needs. This selection of the next question(s) generally depends on the previously asked questions and thus represents a continuously adaptive and learning system.

It should be noted that the present invention is not only directed to assessing the information needs of a patient for use by a care provider, but can be generally used for assessing the information needs of any person. Hence, whenever reference is made herein to a “patient” this shall be generally understood as a “person”. Similarly, a user shall be understood broadly, and whenever reference is made herein to a “care provide” this shall be generally understood as a “user”. In principle, the present invention may be used in any situation where two persons communicate and it is essential that information provided by one of the two persons (e.g., by a healthcare professional, teacher, parent, sales person, etc., i.e. generally a “user” or information provider) is received well by the other person (e.g., by a patient, student, child, buyer etc., i.e. generally a “person” or information receiver).

### BRIEF DESCRIPTION OF THE DRAWINGS

These and other aspects of the invention will be apparent from and elucidated with reference to the embodiment(s) described hereinafter. In the following drawings

FIG. 1 shows a schematic diagram of a first embodiment of a system according to the present invention,

FIG. 2 shows a schematic diagram of a first embodiment of a device according to the present invention,

FIG. 3 shows a schematic diagram of a second embodiment of a device according to the present invention,

FIG. 4 shows diagrams illustrating possible markers for rumination according to the present invention,

FIG. 5 shows diagrams illustrating possible markers for cognitive closure according to the present invention,

FIG. 6 shows a schematic diagram of a second embodiment of a system according to the present invention, and

FIG. 7 shows a flow chart of a method according to the present invention.

### DETAILED DESCRIPTION OF THE INVENTION

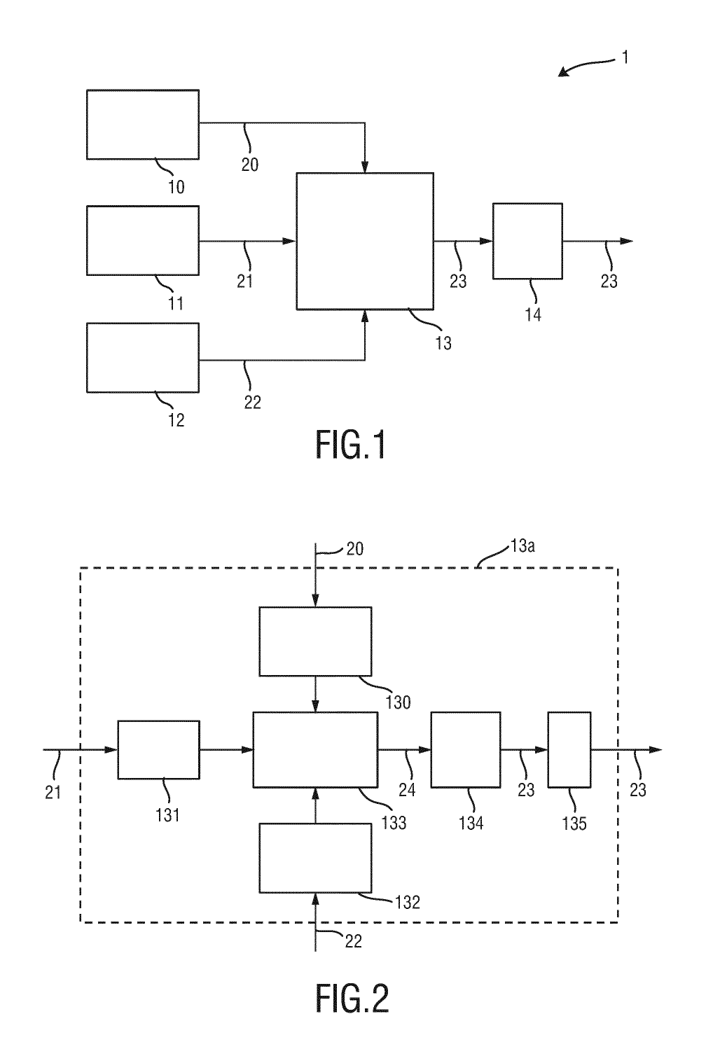

FIG. 1 shows a schematic diagram of a first embodiment of a system 1 for assessing the information needs of a person according to the present invention. It comprises a speech content information acquisition unit 10 for acquiring speech content information 20 including information about the content of speech of the person, an imaging unit 11 for acquiring image data 21 of the person depicting the person during said speech, a physiological data sensor 12 for acquiring physiological data 22 of the person obtained during said speech, a device 13 according to the present invention for assessing information needs 23 of the person, and a user interface 14 for issuing the determined information needs 23 of the person for perception by a user.

The person and the user may generally be any kinds of person, wherein the user generally aims at providing information in the best possible way to the person. For instance, the person may be a patient and the user may be a caregiver, such as a doctor, who wishes to provide healthcare information, such as a treatment plan and treatment actions to be observed, to the patient so that the patient as much as possible understands and follows the healthcare information. Another scenario is the communication between teacher and student, i.e. the person is a student and the user is a teacher, wherein the teacher wishes to transfer knowledge to the student such that the student understands it.

FIG. 2 shows a schematic diagram of a first embodiment of a device 13a according to the present invention. It comprises an input interface 130 for receiving speech content information 20 of the person, including information about the content of speech of said person, an image data interface 131 for receiving image data 21 of the person depicting the person during said speech, and a physiological data interface 132 for receiving physiological data 22 of the person obtained during said speech. A data analyzer 133 the received speech content information, image data and physiological data and derives a topic of the speech from the received speech content information, derives one or more vital signs and reactions of the person from the received image data and derives emotions of the person from the received physiological data. An information needs determining unit 134 determines information needs 23 of the person from the derived data 24 and information, i.e. from the topic of speech, one or more vital signs, reactions and emotions of the person derived by the data analyzer. An output interface 135 is provided for outputting the determined information needs 23 of the person.

The various units of the device 13 may be comprised in one or multiple digital or analog processors depending on how and where the invention is applied. The different units may completely or partly be implemented in software and carried out on a personal computer which is connected to source of speech spoken by the person, e.g. to a microphone or to a storage storing an audio file included prerecorded speech. Some or all of the required functionality may also be implemented in hardware, e.g. in an application specific integrated circuit (ASIC) or in a field programmable gate array (FPGA).

In the following a possible implementation and various embodiments of the elements of the proposed system 1 and device 13 will be explained by reference to the (non-limiting) example of a communication between a patient and a doctor during a consult.

The data analyzer 133 may include a semantic analysis unit for transcribing and semantically annotating what happens during the consult as measured via either video, or audio, or physiological recordings. For example, semantic analysis of audio may include a linguistic analysis providing a transcription of what is said by doctor and patient in text. Furthermore, this text may be annotated with semantic concepts relevant to the patient care domain (e.g. ‘treatment’, ‘side effect’, ‘concern’, etc.). Intonation may also be analyzed to provide indications of emotions. Body posture can be analyzed to provide indications of emotions and the patient's direction of attention. Physiological measures can also provide indications of emotional responses and possibly even how received information is processed by the patient (e.g. via measurements of brain activity).

For instance, existing software and methods are available for such analysis and can be used as described below. Future developments in the area of semantic analysis of such recordings may provide improved embodiments.

The information needs determining unit 134 may be configured to perform a personal characteristics estimation using the annotated recordings of the consult to calculate an estimation of personal characteristics. This may be done via recognition of markers of each of the characteristics. For each characteristic, a number of recognition markers may be defined, e.g. “not talking much” or “keeps repeating the same concern(s)” may be defined as markers of rumination, “does not ask questions” and “doesn't appear to be actively listening” may be defined as markers of cognitive closure, etc. These markers can be taken from expert knowledge (e.g. from psychologists or psychological literature), or they can be derived from an experiment where participant's behavior is recorded via video, audio and or physiological measures and they are asked to fill in questionnaires or talk to a psychologist afterwards in order to get an indication of their psychological profile. Correlations between recorded behaviors and psychological profile indicate which behaviors can be used as markers. The markers might be refined by applying adaptive learning techniques during use of the device and system.

The markers defined by an expert as described above may need to be translated to a more formal representation in order to be able to compare them to the outcome of the semantic analysis unit; e.g. “active listening” may need to be translated to something like: brain activity in prefrontal cortex and/or body posture sitting upright and/or eyes aimed in the direction of doctor and/or nodding and/or saying affirmative words like “yes” or “hm” in response to what doctor explains, etc. When these markers are defined from correlations between semantic analysis of recordings and psychological profiles obtained from questionnaires or interviews by psychologists, they are already formalized/machine readable, because they correspond to the output from the semantic analysis unit.

The presence of markings in recordings of a consult with a patient can be detected as described above in real time and/or after the consult has ended. The presence or absence of certain markers may be used to determine the psychological profile. This profile and/or relevant items from this profile for a particular patient can then be presented to the doctor, either during the consult or afterward, before the next consult. Relevant items may for example be that this patient is likely to ruminate.

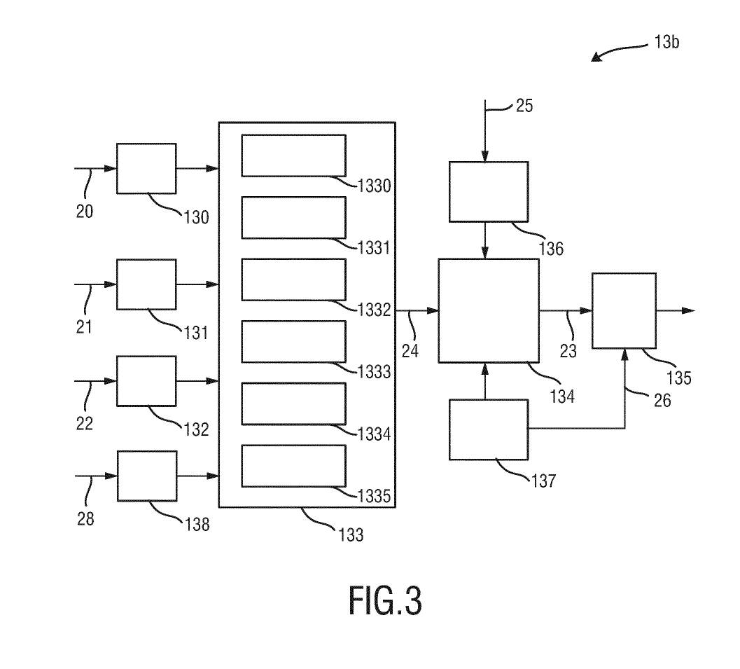

FIG. 3 shows a schematic diagram of a second embodiment of a device 13b according to the present invention. In said embodiment the data analyzer 133 comprises a person recognition unit 1330 for identifying the person from the received data 20, 21, 22. Further, the device 13b comprises a personal data input 136 for obtaining personal data 25 of the identified person and said information needs determining unit 134 is configured to use said personal data 25 in determining information needs of the person.

In addition or alternatively, as also shown in FIG. 3, said data analyzer 133 comprises one or more of
a facial expression recognition module 1331 for recognizing facial expressions of the person from the received image data,
a gesture recognition module 1332 for recognizing gestures of the person from the received image data,
a voice analysis module 1333 for analyzing the voice of the person from received audio data,
a text analysis module 1334 for analyzing received text information, and
a facial color detection module 1335 for detecting the color and/or color changes of the person from the received image data.

Still further, in addition or alternatively, as also shown in FIG. 3, the device 13b comprises a recommendations generator 137 for generating a recommendation 26 how to tailor communication, content of information delivery and/or information delivery style to be provided to the person according to the determined information needs of the person, wherein said output interface 135 is configured to output the recommendation 26.

The device 13b may further optionally comprise a data input 138 for obtaining healthcare information 28 of the person, e.g. from an electronic health record or a database. The data analyzer 133 may then process said healthcare information and said information needs determining unit 134 may then additionally use said healthcare information in determining information needs of the person.

In the following more details of a particular implementation will be described.

The data analyzer 133, in particular a semantic analysis unit provided therein, receives input from different devices and sensors in the form of for example video, audio, heart rate, galvanic skin response (GSR), breathing patterns, etc. It translates these raw recordings to meaningful and relevant higher level abstractions such as
topic of conversation (audio),
stress level (heart rate, galvanic skin response, breathing pattern),
body posture (e.g. sloughed or upright, arms crossed or open, etc.) (video),
direction of gaze (video),
intonation (question or statement, affirmative or doubtful, sad, angry, worried, etc.) (audio),
etc.

Different (at least partly known) methods and/of algorithms for making these translations can be used. For video content analysis (VCA) methods can be used for posture recognition (cf. e.g. M. Whitmore et al., “The Evolution of the Posture Video Analysis Tool (PVAT)”, NASA Technical Paper 3657, November 1996), recognition of movements of the body (cf. e.g. www.contemplas.com describing software for analysis of movement of the body for sporters and patients in order to detect weaknessess), gesture recognition (as e.g. used by Kinect for XBox 360), etc.

For audio analysis methods can be used for speech recognition (as e.g. used for Dragon NaturallySpeaking), emotion recognition from speech (cf. e.g. Zhongzhe Xiao, “Recognition of Emotions in Audio Signals”, Phd Thesis work, 2008), recognition of discourse structure such as “question, answer, backchannel, agreement, disagreement, apology, etc.” (cf. e.g. Daniel Jurafsky et al., “Automatic Detection of Discourse Structure for Speech Recognition and Understanding”, IEEE Automatic Speech Recognition and Understanding Workshop 1997, ASRU 1997, Santa Barbara, Calif., 1 Dec. 1997).

For analysis of physiological measures a number of physiological measures are strong indicators of emotion, such as skin conductance, heart rate, breathing pattern and muscle tension (especially in the face) for example. Skin conductance is easily translated to distress, especially in a context where the sweating does not arise from physical activity, the patient is only sitting in a chair. For heart rate, the same holds as for skin conductance, especially in this specific context, it can be assumed that an increase in heart rate is due to distress. Muscle tension in general may provide an indication of whether the patient is relaxed or tense. Muscle tension in specific muscles, especially in the face, provide good indications of emotion. Much attention is being given to developing wearable physiological sensors and making them as less invasive as possible.

Based on markers defined by an expert, a formal ‘vocabulary’ of what should be able to be detected can be defined. For example, if one of the markers is: “the patient shows signs of distress” then posture, intonation in speech, GSR, heart rate and muscle tension should be translated to a level of distress. If one of the markers is: “the patient asks a lot of questions”, then recognized speech should be translated to a classification of: question versus not a question.

In another embodiment, the markers may be learnt by the system, instead of defined by an expert. In this embodiment, available classification/recognition methods may be used to determine what the vocabulary can be. E.g. it may be chosen to use speech recognition which is speaker independent but has a limited vocabulary (e.g. aimed at the medical domain). Then, the words, sentence structures, etc. which can be recognized by the speech recognition can be used to define which words, sentence structures, etc. might be used as markers. Whether they are eventually used as markers may be determined by the correlation between the word, sentence structure, etc. and the item in the psychological profile.

Hence, the level of semantic analysis which is done in the semantic analysis unit may vary, depending on which markers are defined by the expert and/or which solutions are available (and used in the embodiment of the invention) at the time.

Next, an embodiment of the information needs determining unit 134 shall be described, which may comprise a personal characteristics estimation unit. For each characteristic, a number of recognition markers may be defined on a scale of −1 to 1, indicating the two extremes of the characteristics. Below, an embodiment will be described which estimates rumination and need for cognitive closure. The same method may be applied to all of the characteristics mentioned above and other characteristics which may be found to influence the patient's information needs.

As mentioned above, markers may be defined from expert knowledge or learnt by the device. In this embodiment, it will be described how the invention works when the markers are defined from expert knowledge. It shall be understood that these markers are examples, in other embodiments different markers may be used in addition or instead.

For rumination, a value of +1 means that the patient is estimated to ruminate a lot, a value of −1 means that the patient is estimated to not ruminate at all. Rumination involves repetitive thinking about stressors and worrying. The following positive and negative markers may be defined for rumination:
Positive: Patient doesn't talk much (is preoccupied with thinking)
Negative: Patient is talkative
Positive: Patient is distressed
Negative: Patient is relaxed
Positive: Patient feels sad/depressed
Positive: Patient feels angry
Negative: Patient feels happy.

These markers may be translated to the following concrete semantic information from video and audio analysis and analysis of GSR, heart rate, and muscle tension measured e.g. in shoulders and face:
Amount of talking: Amount of speaking time or number of words spoken by the patient could be compared to the average or a set of predefined amounts which scales the amount of talking into categories: very little, little, average, much, very much.
Whether the patient is distressed can be derived from:
   heart rate: high heart rate indicates distressed
   GSR: high GSR indicates distressed
   muscle tension: lot of muscle tension in shoulders indicates distressed, tension in jaw, teeth clenching
   audio: intonation: patients speaks in higher frequency than usual (can be compared to when the patient entered the room and said hello to the doctor, or to previous sessions, or if the patient had to train the speech recognition software by reading out loud it can be compared to this)
   video: posture indicators of stress: shoulders raised a little, hands grasping something.
      For relaxed state, the opposite holds.
Whether the patient is sad can be derived from:
   analysis of facial expression through muscle tension and/or video
   audio: intonation
Whether the patient is angry can be derived from:
   analysis of facial expression through muscle tension and/or video
   audio: intonation
Whether the patient is happy can be derived from:
   analysis of facial expression through muscle tension and/or video
   audio: intonation
Whether the patient is sad depressed or angry can be derived from:
   tone of speaking
   muscle tension in facial muscles
   face recognition of emotions.

This is preferably all measured over a number of time frames (e.g. every five minutes) and used to derive. For that period of five minutes, a classification is made for each of these markers indicating whether or not they occur, e.g.:
Patient doesn't talk much may occur (and then of course talkative does not occur), but it is also possible that patient doesn't talk much doesn't occur, while talkative also doesn't occur.
Distressed may occur because heart rate is high and there is tension in the shoulders, while the frequency of the voice may not have increased and there is no extra tension in the jaws, on the other hand, distressed may also occur because there is increased tension in the jaws and the frequency of the voice has increased, while the heart rate and tension in the shoulders are still low.
Sad, angry, or happy may occur, but the patient can of course also be in a neutral state, meaning that neither sad, nor angry, nor happy occurs.

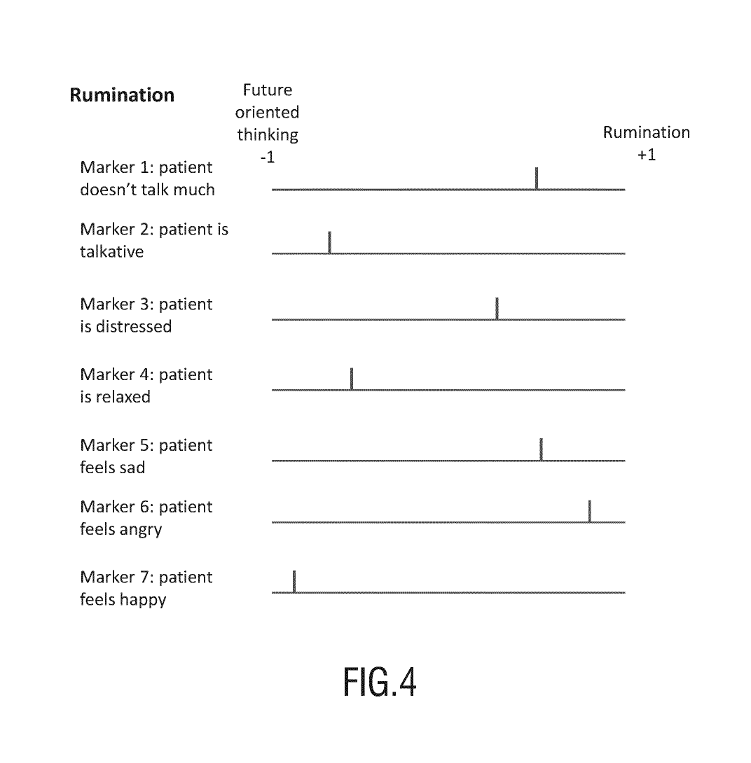

This means that in this example every five minutes a verdict is generated on each of the markers on whether it is present or absent. If a marker is absent, value 0 is added, otherwise, the value allocated to the marker (on a scale of −1 to +1, as depicted in FIG. 4 showing a diagram of the markers for rumination) is added. The score for rumination is determined by adding all of these values on the markers for each time frame that has passed and has been processed and dividing it by the total number of markers for rumination multiplied by the number of time frames that have passed (i.e. the average is taken). A level of confidence on the assessment of rumination is derived from the number of markers which were recognized, the number of time frames that have passed and the variance of the values of the markers:
The more markers were recognized the higher the confidence.
The more time frames have passed, the higher the confidence.
The higher the variance in the values of the recognized markers, the lower the confidence.

For cognitive closure a value of +1 means that the patient has an very strong need for cognitive closure, a value of −1 means that the patient is very capable of applying critical thinking The following markers may be defined for cognitive closure:
Negative: the patient asks a lot of questions
Negative: the patient is very actively listening to what the doctor says
Negative: the patient repeats what the doctor says in his own words correctly
Positive: the patient repeats what the doctor says in his own words incorrectly
Positive: the patient has stopped listening
Positive: the patient becomes agitated by suggestions of different treatment options by the doctor.

These markers can be translated to the following concrete semantic information from video and audio analysis and analysis of GSR, heart rate, and muscle tension measured in shoulders and face:
Number of questions asked can be derived from audio and speech recognition.
Whether or not the patient is actively listening can be derived from video analysis of posture (sloughed for not listening, upright for listening), direction of gaze (fixed on the doctor, or what the doctor is pointing at/looking at for active listening, in another direction for not listening).
To determine whether the patient is correctly or incorrectly repeating what the doctor said, a statement made by the doctor is classified as for example an RDF triple and then do the same for the response of the patient and check if the triples are the same or not.
To determine whether the patient becomes agitated by suggestions of different treatment options, the speech of the doctor is analyzed to determine when treatment options are discussed and measure in the same time frame, for the patient whether his heart rate and/or GSR have increased, whether his muscles are more tense, and whether his speech has become higher.

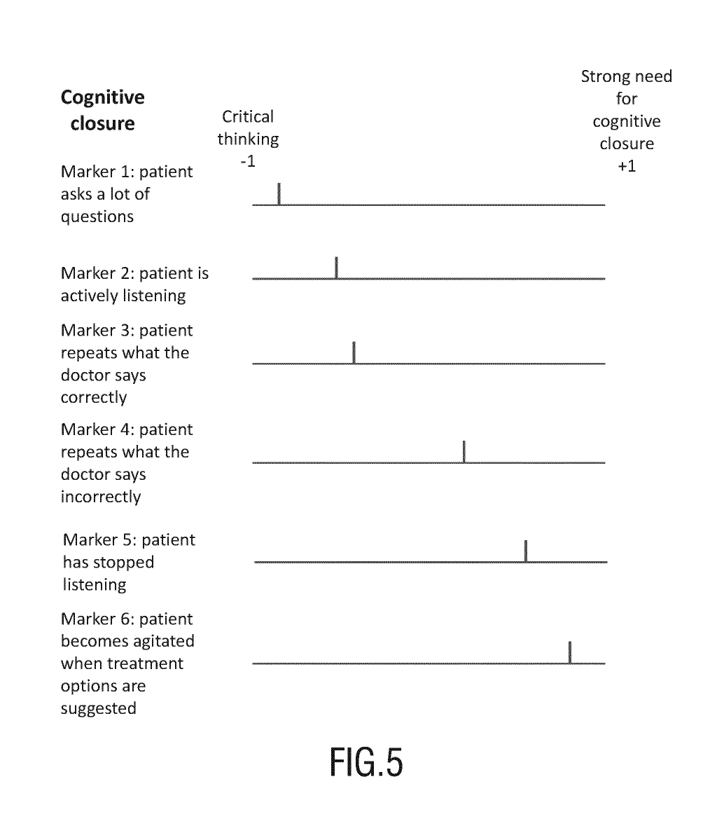

Similar as for rumination, this is measured in predefined time frames, e.g. of five minutes, and an average score (based on the values as depicted in FIG. 5 showing a diagram of the markers for cognitive closure) and confidence are calculated and presented to the doctor.

The number of markers defined may be different, in particular much larger, so as to provide a solid basis for making conclusions on whether or not the patient is ruminating, or has a need for cognitive closure. Furthermore, as said before, the psychological profile may include more items or different items, depending on which items are thought most heavily influence the patient's information need.

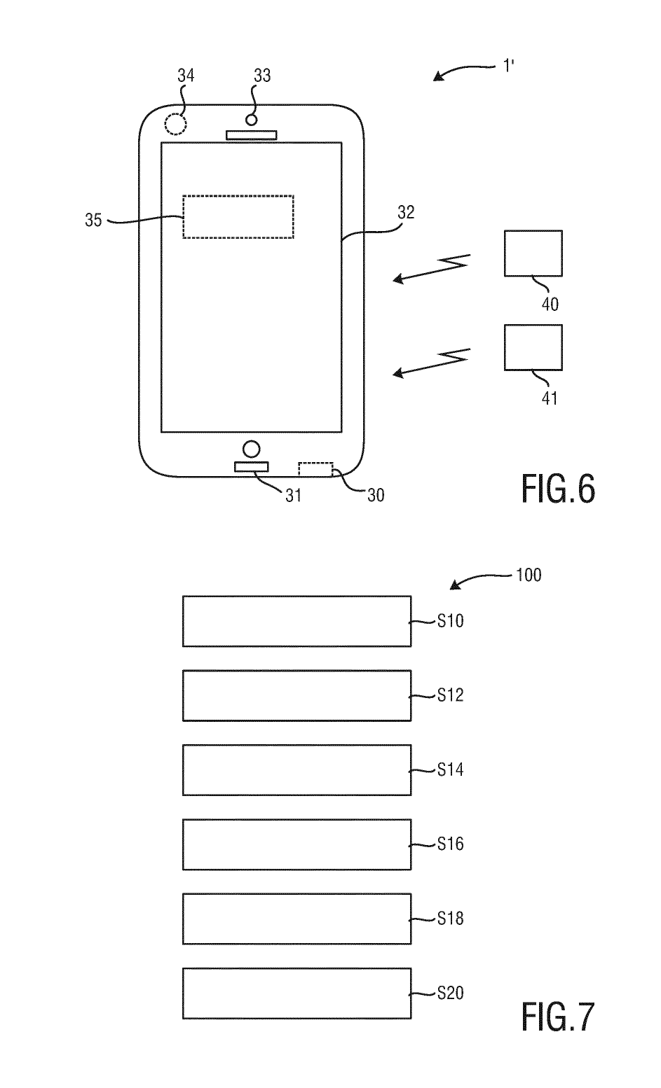

Generally, the system according to the present invention may be configured differently, e.g. as distributed system using one or more separate elements which are configured for wired or wireless data transfer. For instance, the device 13 may be configured as computer or processor, to which the elements 10, 11, 12 transfer the data, and the user interface 14 may be a display on the device or also at a different location separate from the device. In other embodiments the system may be incorporated into or configured as a handheld or mobile device, in particular a smartphone, tablet, laptop, wrist-mounted device or camera. FIG. 6 shows a schematic diagram of a second embodiment of a system 1′ according to the present invention according to which at least part of the system 1′ is configured as smartphone.

According to this system the speech content information acquisition unit comprises one or more of an audio data interface, e.g. a data interface 30 of the smartphone (e.g. a data port for receiving audio files (e.g. an MP3 file, a MIDI file, etc.) or audio data in any other format), for receiving audio data files of recorded speech, an audio recording unit, e.g. the microphone 31 of the smartphone, for converting spoken speech into electric speech signals, and an interrogator, e.g. the display 32, for interrogating the person.

The display 32 may further be used as user interface for outputting the determined information needs and, if available, recommendations how to tailor communication, content of information delivery and/or information delivery style to be provided to the person according to the determined information needs of the person. The front camera 33 and/or the rear camera 34 may be used as imaging unit for acquiring image data of the person depicting the person during speech. One or more external sensors 40, 41, which may be coupled wirelessly or in a wired manner with the smartphone, may be provided as physiological data sensor for acquiring physiological data of the person obtained during said speech. The processor 35 of the smartphone preferably represents the device for assessing information needs of the person based on the acquired data.

FIG. 7 shows a flow chart of a method 100 according to the present invention. In a first step S10 speech content information of the person, including information about the content of speech of said person, is received. In a second step S12 image data of the person depicting the person during said speech are received. In a third step S14 physiological data of the person obtained during said speech are received. In a fourth step S16 the received speech content information, image data and physiological data are analyzed to derive a topic of the speech from the received speech content information, one or more vital signs and reactions of the person from the received image data and emotions of the person from the received physiological data. In a fifth step S18 information needs of the person are determined from the topic of speech, one or more vital signs, reactions and emotions of the person derived by the data analyzer. Finally, in a sixth step S20 the determined information needs of the person are outputted.

In another embodiment the system is configured as a bracelet or wristworn device. The person's emotions may e.g. measured with a heart rate measurement device by adding a galvanic skin response (GSR) sensor into it. Such a device is able to measure heart rate from the wrist of the user by using light to measure blood flow variations and applying algorithms (e.g. as known from photoplethysmography) using blood flow information together with accelerometer data to compensate for movement artefacts. The content of a discussion could be recorded with an audio recorder in the bracelet. Movements of the person may be recorded with an integrated accelerometer and depending on the location of the device, maybe also posture could be detected. The bracelet could be applied at user's (e.g. doctor's) office in a similar manner than a blood pressor sensor, i.e. as an additional device needed to get the necessary outcome.

Generally, the device may be configured in the form of a bracelet, watch, armband with sensors that are able to measure HR. In principle if more sensors are integrated into the device than only the light sensors, also the galvanic skin response could be measured or even ECG from the wrist. ECG could be used as a reference for the heart rate measured with light. These signals should again be conditioned with algorithms to reduce effect of motion artefacts in the results.

Instead of using an audio recorder, the camera (e.g. the vital signs camera or completely different camera) can be used to detect the movement of the mouth and the lips to decode what is being discussed during the patient-doctor discussion. The information can be recorded using camera, image based processing would be applied to decode the content of the discussion from the images and this content may then be stored and analyzed for certain key-words. The time-stamped key-words could then be correlated to the measurement results of the patient emotions.

Alternatively or in addition electronic paper may be used to record and transcript the notes made by the doctor into electronic format. This transcription again could be time-stamped and related to the emotions.

Further, a computer implemented application (“app”) may be used to guide and support the doctor-patient interaction on deciding on the appropriate treatment. This app could record the touches on the screen and could be used to collect information about the doctor-patient interaction to relate the patient's feelings to a topic. There could be several other elements also to record, like the time from asking the question to touching the screen, absolute time of the question to relate to emotions measured with another device (WeST-like or camera app or something else), which image was touched etc. This would add to a database to help in assessing the type of the patient.

In a practical scenario, the assessment may be done during a meeting with a patient and the assessment result would be available only during the next confrontation with the patient. However, also a real-time assessment would be possible and could be shared with the doctor immediately, during the discussion. This requires an active link from the patient device(s) or the monitoring database to the doctor's device. The doctor's device could guide the doctor real time in a format of a storyline or keywords and adjust those according to the result of the patient assessment so that the correct wording would be used to maximize information transfer between the doctor and the patient. The background of the doctor's screen could change in color or image to quickly indicate to the doctor, which type of patient the current one is and which kind of communication style needs to be used with the patient (light colors, flowers, smooth lines for a patient that tends to worry, etc.).

Further, the usage of the real-time tool and indication of the patient type to the doctor can be used to increase/decrease the sensitivity of the personality type detection algorithm by utilizing existing data from the patient. For example, if a patient is known to exhibit worrying behaviors, the heart rate variability or sweating could be interpreted in a different way in the model than for a patient without this kind of history. This would be especially helpful in the real time version of the tool to be able to interpret the emotions of the patient correctly in the moment where less data might be available than in the post-assessment where the complete visit would have been recorded.

Especially in the case of cognitive closure, the patient is not aware of his/her way of looking at the world. Hence, it can be provided that a subtle information is fed back to the patient to inform him about the challenges he might encounter because of his personality. This feedback could be hooked into the loop in a form of a patient app on the patient's phone/tablet/PC. The app would both contain the information discussed at the appointment to increase information retention by repetition and some hints how to cope with his personality and maybe change it slowly. The app would also personalize the information according to the communication needs of the patient (see real-time guidance to the doctor).

The device 13 may further comprise an optional translator for translating the received speech into text. This may be implemented by a known algorithm, as e.g. used in dictation systems or speech recognition systems used in automated call centers. Many of such speech recognition algorithms are known and used in practice, which may generally be used by the translator.

The device 13 may further comprise a language processor 16 for analyzing the speech and/or text to identify predetermined natural language elements. Such predetermined natural language elements include one or more of the amount and/or length of pauses, the length of sentences and/or words, the amount of words in a sentence, the amount of verbs, nouns, adjectives and/or possessive pronouns, the amount of words with predetermined prefixes and/or endings (e.g., if the language is English, the number words ending with “ed” versus the number of words ending with “ing”), the amount of layman's words or phrases, the amount how much the person speaks about a predetermined topic, the extent to which the person uses predetermined words or phrases.

The information needs determination unit 134 may implemented by use of a look-up table listing the different obtained data and optionally natural language elements versus the corresponding information needs. In another embodiment said information needs identifier is implemented as a rule-based engine.

The results and recommendations can be fine-tuned when the recorded data of the specific persons builds up over time and the accuracy of the results increases. An extendable user interface may show the outcome of the analysis. For instance, characteristics could be added and removed. Further, the device may be configured to only select from main groups of characteristics and information needs, or the system may be extended to determine more characteristics and information needs. Additionally, the device could provide tailored information or provide guidelines for the healthcare providers on which interventions could be most effective for the particular person.

In case of using an interrogator, preferably open ended questions are asked by the interrogator to the person so that the person needs to answer the questions by using natural speech including not only a single word like “yes” or “no”.

In other embodiments of the input interface not including an interrogator the person is not asked certain questions by the system, but the system simply records any speech by the person, e.g. from a talk with a visitor, a care provider or any other person, and evaluates said speech.

In preferred embodiments the device is configured to take potential information needs into account and is adapted to be able to determine data that are typical for such information needs and help in the identification of such information needs.

As explained above a tailored information approach is advantageous, because knowledge about a patient's information needs can help the healthcare provider to tailor information and/or information-style to the patient and to optimize patient experience and patient adherence. Further, many healthcare provider-patient conversations have a standard format, in which the healthcare provider has limited time to ask a predetermined number of questions to or to discuss a predetermined number of matters with the patient.

Further embodiments of a device and system according to the present invention are thus directed to minimize the patient-healthcare provider burden in identification of the patient's information needs by combining obtrusive identification methods with unobtrusive methods to use the costly (but effective) obtrusive methods when deemed necessary by the healthcare provider and/or employing uncertainty and/or information entropy data, to identify the patient's information needs as fast or with as little use of resources as possible, as will be explained below.

These further embodiments aim at minimizing the uncertainty about the information needs of a patient based on processing the spoken language extracted from healthcare provider—patient communication and guiding the healthcare provider in triggering a specific dialogue that will lead to information most likely to decrease the uncertainty. For this purpose a certainty parameter (sometimes also referred to as “uncertainty parameter”) corresponding to the level of certainty (or uncertainty) about the information needs and/or an information entropy parameter (the information entropy being a measure of the amount of uncertainty solved by answering the question, as e.g. currently described under the link http://en.wikipedia.org/wiki/Entropy_(information_theory)) corresponding to the expected value of information for determining the information needs) in a response of a patient to a certain healthcare provider question.

The present invention can preferably be applied in the healthcare domain as a support system for doctors who do consults regularly, e.g. in a Clinical Decision Support System (CDS). When such a CDS is used in a setting where patient involvement is important, this invention may be deployed within or in addition to the CDS. Examples of such situations are:
In treatment of cancer often multiple treatment options are available and the effectiveness of the different options is comparable, or effectiveness depends very much on whether the patient is willing to adhere to the treatment plan. It is important that patients are well aware of the risks and chances of effectiveness of treatment and their own required involvement (such as: Do I need to go to the hospital? How often? Can I stay at home?).
In treatment and/or management of chronic diseases, strong patient involvement is required. If there are multiple treatment options, then it is important that the patient understands the consequences of each option, because he/she will have to live with it for the rest of his/her life.
In terminal diseases patient involvement is very important, because there are always multiple options: the patient can choose to stop all treatment, or he can opt for several levels of palliative care, in the hospital or at home. It is important here that the patient understands the consequences of his/her choice for the duration and quality of his/her life.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A device for assessing information needs of a person, the device comprising:
an input interface for receiving speech content information of the person,
an image data interface for receiving image data of the person depicting the person during said speech,
a physiological data interface for receiving physiological data of the person obtained during said speech,
a data analyzer for analyzing the received speech content information, image data and physiological data and for deriving a topic of the speech from the received speech content information, for deriving one or more vital signs and reactions of the person from the received image data and for deriving emotions of the person from the received physiological data,
an information needs determining unit for determining information needs of the person from the topic of speech, one or more vital signs, reactions and emotions of the person derived by the data analyzer, and
an output interface for outputting the determined information needs of the person.

2. The device as claimed in claim 1,
wherein said input interface is configured to receive audio data of speech spoken by the person, video data of at least the person's mouth and/or text data indicating the content of the person's speech.

3. The device as claimed in claim 1,
wherein said image data interface is configured to receive a sequence of image frames of the person, said image frames including image data of one or more skin areas of the person, and wherein said data analyzer is configured to obtain one or more vital signs of the person from said sequence of image frames by use of remote photo-plethysmography.

4. The device as claimed in claim 1,
wherein said data analyzer comprises a person recognition unit for identifying the person from the received data,
wherein the device further comprises a personal data input for obtaining personal data of the identified person, and
wherein said information needs determining unit is configured to use said personal data for determining information needs of the person.

5. The device as claimed in claim 1,
wherein said data analyzer comprises one or more of
a facial expression recognition module for recognizing facial expressions of the person from the received image data,
a gesture recognition module for recognizing gestures of the person from the received image data,
a voice analysis module for analyzing the voice of the person from received audio data,
a text analysis module for analyzing received text information, and
a facial color detection module for detecting the color and/or color changes of the person from the received image data.

6. The device as claimed in claim 1,
wherein said information needs determining unit is configured to determine personal characteristics of the person by use of one or more markers, wherein said one or markers correlate personal characteristic with one or more topics of speech, vital signs, reactions and/or emotions of the person, and to determine information needs based on the determined personal characteristics.

7. The device as claimed in claim 1,
further comprising a recommendations generator for generating a recommendation how to tailor communication, content of information delivery and/or information delivery style to be provided to the person according to the determined information needs of the person,
wherein said output interface is configured to output the recommendation.

8. The device as claimed in claim 1,
further comprising a data input for obtaining healthcare information of the person, wherein said data analyzer is configured to process said healthcare information and wherein said information needs determining unit is configured to use said healthcare information in determining information needs of the person.

9. A system for assessing information needs of a person, the system comprising:
a speech content information acquisition unit for acquiring speech content information,
an imaging unit for acquiring image data of the person depicting the person during said speech,
a physiological data sensor for acquiring physiological data of the person obtained during said speech,
a device as claimed in claim 1 for assessing information needs of the person, and
a user interface for issuing the determined information needs of the person for perception by a user.

10. The system as claimed in claim 9,
wherein said speech content information acquisition unit comprises i) an audio data interface for receiving audio data files of recorded speech, and/or ii) an audio recording unit, in particular a microphone, for converting spoken speech into electric speech signals, and/or iii) an interrogator for interrogating the person.

11. The system as claimed in claim 9,
wherein the system is incorporated into or configured as a handheld or mobile device, in particular a smartphone, tablet, laptop, wrist-mounted device or camera.

12. A method for assessing information needs of a person, the method comprising:
receiving speech content information of the person,
receiving image data of the person depicting the person during said speech,
receiving physiological data of the person obtained during said speech,
analyzing the received speech content information, image data and physiological data and for deriving a topic of the speech from the received speech content information, for deriving one or more vital signs and reactions of the person from the received image data and for deriving emotions of the person from the received physiological data,
determining information needs of the person from the topic of speech, one or more vital signs, reactions and emotions of the person derived by the data analyzer, and
outputting the determined information needs of the person.

13. A computer program product comprising a computer readable medium having computer readable code embodied therein, the computer readable code being configured such that, on execution by a computer or processor, the computer or processor is caused to perform the method of claim 12.
